(19) United States
(12) Patent Application Publication
(10) Pub. No.: US 2010/0036566 A1
(43) Pub. Date: Feb. 11, 2010

(54) TORQUE CONTROLLER FOR ON-VEHICLE POWER GENERATOR

(75) Inventor: Toshifumi HAYAMI, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/533,369

(22) Filed: Jul. 31, 2009

(30) Foreign Application Priority Data
Aug. 6, 2008 (JP) 2008-202729

(51) Int. Cl. G06F 19/00

(52) U.S. Cl. 701/48

(57) ABSTRACT

When it is determined that accelerator operation and brake operation are performed at the same time based on the output values of an accelerator sensor and a stop lamp switch, a torque of an engine is reduced based on a brake pedal force which is computed based on a pressure in a negative pressure chamber of a master bag and a brake oil pressure.

### CROSS-REFERENCE TO RELATED APPLICATION

This application is based on Japanese Patent Application No. 2008-202729 filed on Aug. 6, 2008, the disclosure of which is incorporated herein by reference.

### FIELD OF THE INVENTION

The present invention relates to a torque controller for on-vehicle power generator.

### BACKGROUND OF THE INVENTION

In a vehicle applied to such a torque controller, the vehicle includes a brake booster which assists the brake pedal force. The brake booster assists a brake pedal force of a driver by use of a differential pressure between the negative pressure downstream of a throttle valve in the intake pipe and an atmospheric pressure, so that the brake torque is increased.

When the accelerator pedal is stepped by the driver and then the accelerator pedal is released, the accelerator pedal may not return to the original position due to a floor carpet. In such a case, the throttle valve opening becomes larger than a case where the accelerator pedal is released, and the torque of a gasoline engine becomes larger than the driver's intention. Furthermore, the negative pressure downstream of the throttle valve becomes small. When a brake operation is performed in a vehicle equipped with the brake booster, the brake booster can not be operated normally and the brake torque can not be obtained sufficiently.

As shown in JP-2005-291030A, when it is determined that the accelerator operation and the brake operation are performed at the same time, the throttle opening is compulsorily varied to an idle position. Besides, as shown in JP-61-008442A and JP-02-502558A, when it is determined that the accelerator operation and the brake operation are performed at the same time, it is determined that an accelerator sensor is abnormal to perform fail-safe operation. JP-U-05-050043A and Japanese utility model No. 2527323 show the engine output is reduced to stop the engine and an automatic transmission is controlled.

In a race, the driver steps the accelerator pedal by right foot and steps the brake pedal by left foot intentionally. According to the device disclosed in JP-2005-291030A, the output of the engine is reduced to an idle condition and the torque of the gasoline engine is rapidly reduced, so that a drivability is deteriorated.

Such a problem is not limited to a gasoline engine. In any other power generator of which torque is adjusted by an accelerator operation by the driver, when it is determined that the accelerator operation and the brake operation are performed at the same time, the drivability is deteriorated.

### SUMMARY OF THE INVENTION

The present invention is made in view of the above matters, and it is an object of the present invention to provide a torque controller for on-vehicle power generator which is able to suitably restrict a deterioration of the drivability even if it is determined that the accelerator operation and the brake operation are performed at the same time.

According to the present invention, a torque controller for an on-vehicle power generator includes: an accelerator information obtaining means for obtaining an operation condition of an accelerator operation member which is operated by a driver to indicate a generation of a driving torque of a vehicle; a brake information obtaining means for obtaining an operation condition of a brake operation member which is operated by the driver to indicate a braking torque of the vehicle; and a torque reducing means for reducing a torque of the on-vehicle power generator according to an output value of the brake information obtaining means when it is determined that both the accelerator operation and the brake operation are performed based on outputs of the accelerator information obtaining means and the brake information obtaining means.

When both the accelerator operation and the brake operation are performed at the same time, the torque reducing means reduces the torque of the power generator according to an output value of the brake information obtaining means. Thereby, the torque of the power generator can be reduced according to an indication of the braking torque of the driver. A total torque of a driving torque and a braking torque can be moved closer to a driver's intention.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 shows an entire structure of a brake system and an engine control system according to an embodiment;

FIG. 2A is a chart showing a relationship between the brake oil pressure and a brake torque;

FIG. 2B is a chart showing a relationship between the brake pedal force and the brake oil pressure;

FIG. 3 is a flowchart showing a torque reducing processing; and

FIG. 4 is a flowchart showing a brake pedal force learning processing.

### DETAILED DESCRIPTION OF EMBODIMENTS

An embodiment of a torque controller applied to a gasoline engine will be described hereinafter.

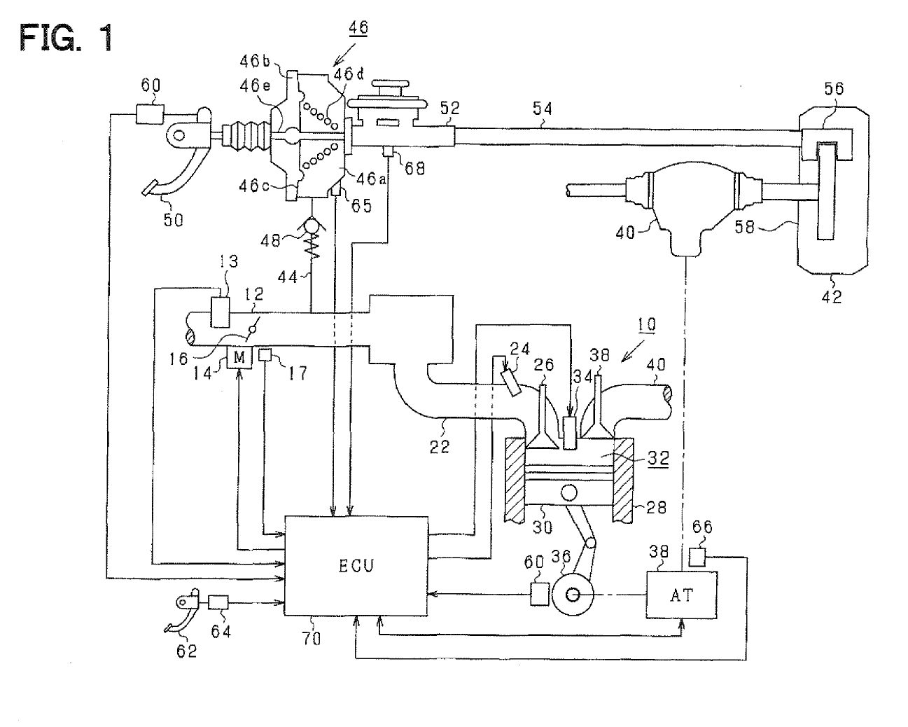

FIG. 1 shows an entire structure of a brake system and an engine control system in the present embodiment. An air flow meter 13 detecting an intake air quantity is provided in an intake pipe 12. A throttle valve 16 is provided downstream of the air flow meter 13. The throttle valve 16 is electrically driven by a throttle actuator 14 such as a DC motor. A position of the throttle valve 16 is detected by a throttle position sensor 17 provided in the throttle actuator 14. An intake manifold 22 is connected to the intake pipe 12 downstream of the throttle valve 16. The intake manifold 22 introduces intake air into each cylinder. A fuel injector 24 is provided at a vicinity of an intake air port of the intake manifold 22 of each cylinder to inject fuel into the cylinder.

An intake valve 26 is provided at the intake port of the engine 10. When the intake valve 26 is opened, each branch pipe of the intake manifold 22 is communicated with a combustion chamber 32 defined by a cylinder block 28 and a piston 30. The fuel injected by the injector 24 is introduced into the combustion chamber 32 with an intake air. A spark plug 34 is provided in the combustion chamber 32. The spark plug 34 ignites the fuel in the combustion chamber. The energy generated by the fuel combustion is converted into a rotational energy of a crank shaft 36 through a piston 30. The combusted fuel is discharged into an exhaust pipe 40 when an exhaust valve 38 is opened.

An automatic transmission 38 is connected to the crank shaft 36. The rotational energy of the crank shaft 36 is varied by the automatic transmission 38 and a final gear of a differential gear box 40, and is transmitted to a drive wheel 42.

The intake pipe 12 is connected to a negative pressure chamber 46a of a master bag 46 through a negative pressure supply pipe 44. The master bag 46 includes a diaphragm defining the negative pressure chamber 46a and an atmospheric chamber 46b, a return spring 46d biasing the diaphragm toward the atmospheric chamber 46b, and an output rod 46e extending from a center portion of the diaphragm 46c. One end of the output rod 46e is connected to a brake pedal 50, and the other end of the output rod 46e is connected to a piston (not shown) of a master cylinder 52. A check valve 48 is provided in the negative pressure supply pipe 44. The check valve 48 permits an airflow from the negative chamber 46a to the intake pipe 12.

When the brake pedal 50 is not stepped, the negative pressure chamber 46a communicates with the atmospheric chamber 46b in the master bag 46. The negative pressure is introduced into the negative pressure chamber 46a through the negative pressure supply pipe 44. The pressure in the negative pressure chamber 46a and the pressure in the atmospheric chamber 46b become identical. When the brake pedal 50 is stepped, the negative pressure chamber 46a does not communicate with the atmospheric chamber 46b. The atmospheric pressure is introduced into the atmospheric chamber 46b. Thus, a differential pressure is generated between the negative pressure chamber 46a and the atmospheric chamber 46b. A center portion of the diaphragm 46c is displaced toward the negative pressure chamber 46a against a biasing force of the return spring 46d. The output rod 46e is also displaced. Thereby, the brake pedal force of the brake pedal 50 is assisted by a specified magnification. The assisted brake pedal force is transmitted to a piston (not shown) of the master cylinder 52 through the output rod 46e. The brake pedal force is converted into a brake oil pressure of the brake oil system. The brake oil pressure is supplied to a brake cylinder 56 through an oil pressure pipe 54. A piston (not shown) of the brake cylinder 56 is displaced by the brake oil pressure, and a brake pad is pressed to a disc rotor 58 to generate a braking torque.

When the brake pedal is released, the negative pressure chamber 46a communicates with the atmospheric chamber 46b and the atmospheric pressure is not introduced into the atmospheric chamber 46b. The atmospheric pressure in the atmospheric chamber 46b is discharged into the intake pipe 12 through the negative pressure chamber 46a, the negative pressure supply pipe 44 and the check valve 48. Thereby, the center portion of the diaphragm 46c is displaced toward the atmospheric chamber 46b by a biasing force of the return spring 46d. The assist of the brake pedal force is canceled.

Besides, that the above-mentioned negative pressure is expressed by differential pressure with the atmospheric pressure.

A stop lamp switch 60 is connected to the brake pedal 50. The stop lamp switch 60 is switched between ON and OFF according to a stepped amount of the brake pedal 50. The accelerator pedal 62 is provided with an accelerator position sensor 64. A negative pressure sensor 65 is provided in the negative pressure chamber 46a in order to detect pressure therein. Specifically, the negative pressure sensor 65 outputs ON-condition signal or OFF-condition signal according to whether the master bag 46 can be operated normally. The master cylinder 52 is provided with an oil pressure sensor 68 detecting a brake oil pressure. A crank angle sensor 60 detecting a crank angle of the crank shaft 36 is disposed at a vicinity of the crank shaft 36. A vehicle speed sensor 66 is disposed at a vicinity of an output shaft of an automatic transmission. Output signals of the above sensors and output signals of an air flow meter 13, a throttle position sensor 17 and the automatic transmission 38 are inputted into an electronic control unit (ECU) 70.

The ECU 70 includes a microcomputer which is comprised of a CPU, a ROM, and a RAM. The ECU 70 executes a various control program stored in the ROM to perform each control according to the engine driving condition.

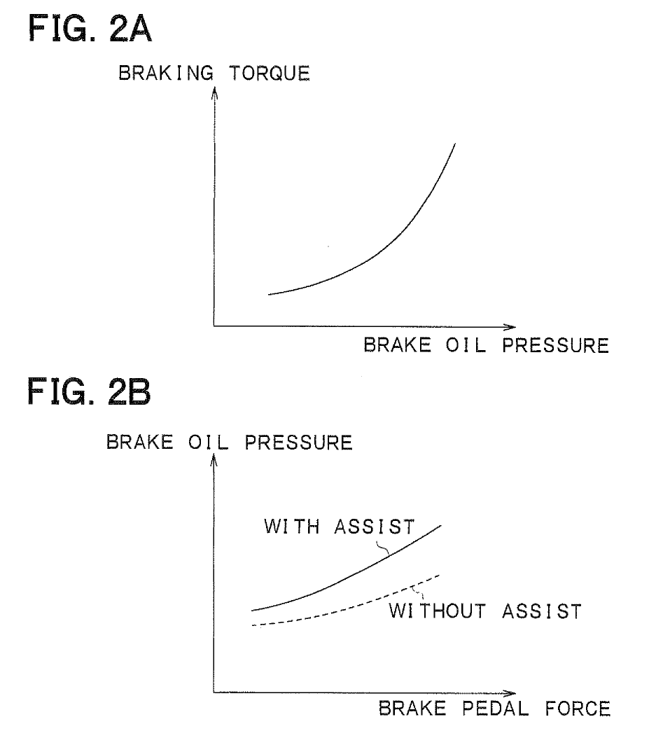

FIG. 2A shows a relationship between a brake oil pressure and a braking torque. FIG. 2B shows a relationship between a brake pedal force and a brake oil pressure.

As shown in FIG. 2A, as the brake oil pressure increases, the braking torque becomes larger. As shown by a solid line in FIG. 2B, as the brake pedal force increases, the brake oil pressure increases.

In the above brake system, the negative pressure in the intake pipe 12 is utilized to assist brake operation. When the throttle valve 16 is largely opened, as shown by dashed line in FIG. 2B, the brake pedal force is not assisted and the brake oil pressure is decreased. When the accelerator pedal 62 does not return to the original position due to a floor carpet, the braking torque can not be obtained according to a driver's decelerating intention. According to the present embodiment, the driver's decelerating intension is confirmed based on the brake pedal force. A torque reducing processing of the engine 10 is conducted based on the brake pedal force. Furthermore, according to the present embodiment, a learning processing of the brake pedal force is executed in order to grasp driver's decelerating intension with high accuracy.

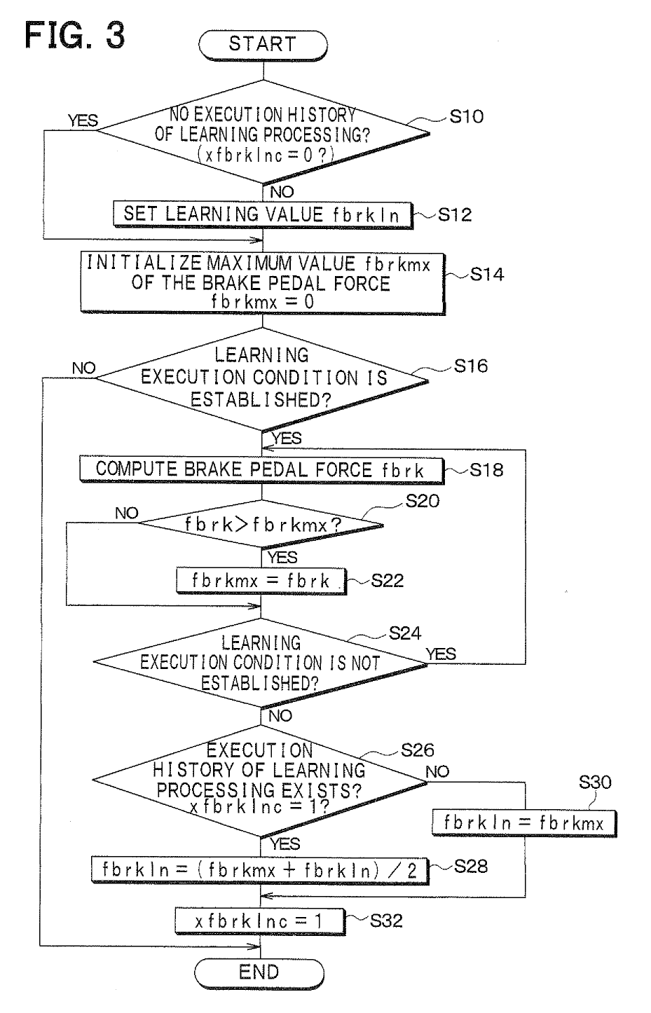

FIG. 3 is a flowchart showing a learning processing of the brake pedal force. This learning processing is repeatedly executed at a specified time interval by the ECU 70.

In step S10, the computer determines whether an execution history of the learning processing does not exist. When the learning history flag xfbrklnc is “0”, the computer determines that the execution history of the learning process does not exists. When the computer determines that the execution history of the learning process does not exist, the procedure proceeds to step S12.

In step S12, a learning value fbrkln of the brake pedal force is set to a minimum value of an average driver's brake pedal force. This processing is to avoid underestimate the driver's decelerating intention when the execution history of the learning process does not exist. In step S14, the maximum value fbrkmx of the brake pedal force is initialized to “0”. Then, the procedure proceeds to step S16.

In step S16, the computer determines whether a learning execution condition is established. This processing is for determining whether it is a condition where an ordinal brake pedal force can be learned. According to the present embodiment, the learning execution condition is a logical product of a condition where the stepped amount of the accelerator pedal is “0” based on an output value of the accelerator sensor 64, a condition where the stop lamp switch is ON, a condition where the vehicle speed is within a specified range, and a condition where deceleration speed is within a specified range. This is based on that a travel speed and deceleration speed is within a constant limit at the time of vehicle traveling on the public road in accordance with a traffic flow. When the vehicle is decelerate, the accelerator pedal 62 and the brake pedal 50 are not stepped at the same time. Therefore, as for each predetermined above-mentioned range of the travel speed and deceleration speed of a vehicle, it is desirable to establish based on the running mode specified by attestation examination and the data acquired to the monitor driving on the public road.

Under the condition above learning execution condition is established, processings in steps S18-S24 are executed in order to set the maximum value of the brake pedal force to the learning value of the brake pedal force. In step S18, a brake pedal force fbrk is computed based on an output of the negative pressure sensor 65 and the oil pressure sensor 68. The output of the oil pressure sensor 68 is a parameter having a correlation with the brake pedal force. As shown in FIG. 2B, the brake pedal force is not defined only by the brake oil pressure. The brake pedal force depends on a negative pressure downstream of the throttle valve 16. Specifically, as the brake oil pressure is higher, the brake pedal force is larger. When the brake oil pressure is constant, as the negative pressure is smaller, the brake pedal force is larger.

In step S20, the computer determines whether the brake pedal force fbrk is greater than the maximum value fbrkmx of the brake pedal force. When the answer is Yes in step S20, the procedure proceeds to step S22 in which the brake pedal force fbrk computed in step S18 is set to the maximum value fbrkmx of the brake pedal force.

In step S24, the computer determines whether the learning execution condition is not established. When the computer determines that the learning execution condition is established, the procedure goes back to step S18. When the computer determines that the learning condition is not established, the procedure proceeds to step S26.

In step S26, the computer determines whether an execution history of the learning processing exists. Specifically, when the learning history flag xfbrklnc is “1”, the computer determines that an execution history of a learning process exists. When the answer is Yes in step S26, the procedure proceeds to step S28 in which a learning value of the brake pedal force is updated. According to the present embodiment, the learning value fbrkln of the brake pedal force is a simple moving average of the previous learning value fbrkln and the current maximum value fbrkmx. When the answer is No in step S26, the procedure proceeds to step S30 in which the learning value of the brake pedal force is the brake pedal force computed in step S18.

Then, the procedure proceeds to step S32 in which the learning history flag xfbrklnc is set to “1”.

When the answer is No is step S16, the procedure ends.

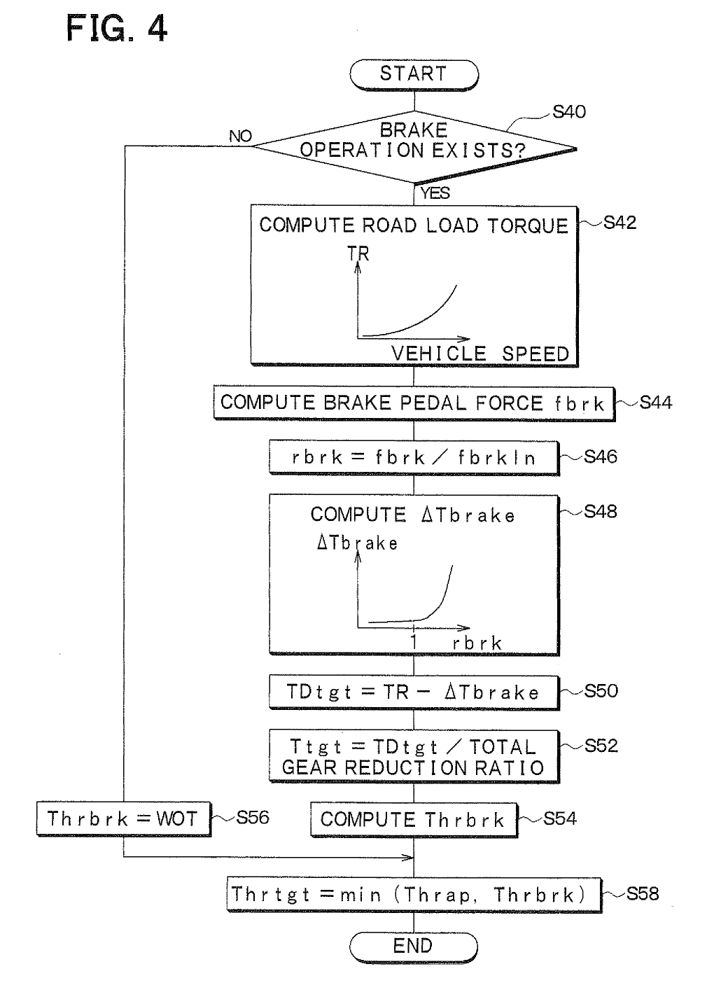

Referring to FIG. 4, an engine torque reducing processing will be described. This process is repeatedly performed at a specified period by the ECU 70.

In step S40, the computer determines whether a brake operation exists. When the stop lamp switch 60 is ON, the computer determines that the brake operation exists. When the answer is Yes in step S40, the procedure proceeds to step S42.

In step S42, a driving torque TR (road load torque) of a vehicle is computed based on a detected value of the vehicle speed sensor 66 for driving a vehicle at a constant speed in a specified running condition. The specified running condition has parameters such as friction coefficient of the road, slope, and wind velocity. Since the road load torque TR receives a friction of the driving wheel 42 and an air resistance of the vehicle, the road load torque is made larger as the vehicle speed is larger. In step S44, the brake pedal force fbrk is computed. In step S46, a normalized brake pedal force rbrk is computed by dividing the brake pedal force fbrk by the learning value fbrkln. This processing is for grasping a driver's deceleration intention by comparing the learning value of the brake pedal force with the actual brake pedal force.

In step S48, a reduced amount ΔTbrake of the driving torque is computed based on the normalized brake pedal force. When the normalized brake pedal force is around “1”, it is supposed that a brake torque is obtained according to the deriver's intention. When the normalized brake pedal force largely exceeds “1”, the driver steps the brake pedal 50 strongly than usual. It is supposed that a brake torque is not obtained according to the deriver's intension. According to the present embodiment, as the normalized brake pedal force is larger, the reduced amount of the driving torque is more increased. Specifically, when the normalized brake pedal force is under “1” or around “1”, the reduced amount of driving torque is set to small value. When the normalized brake pedal force largely exceeds “1”, the reduced amount of the driving torque is continuously increased as the brake pedal force is larger.

In step S50, a target driving torque TDtgt is computed by subtracting the reduced amount ΔTbrake of the driving torque from the road load torque TR. In step S52, the target generation torque Ttgt of the engine 10 is computed by dividing the target driving torque by a total gear reduction ratio.

In step S54, an upper limit value Thrbrk of the target throttle valve opening of the throttle valve 16 is computed. The throttle opening necessary for obtaining target generation torque is computed. Specifically, the necessary throttle opening is computed based on the target generation torque and the engine speed. A larger one of the necessary throttle opening and a throttle opening at idle speed control is set to an upper limit of the target throttle opening. This is to avoid the throttle opening becomes excessively small.

When the answer is No in step S40, the procedure proceeds to step S56 in which the upper limit Thrbrk of the target throttle opening is set to wide open throttle (WOT).

In step S58, a smaller one of the usual throttle opening and an upper limit value of the target throttle is computed as the target throttle opening. This process is for reducing the torque of the engine 10 according to the normalized brake pedal force.

When the process in step S58 is finished, the processing ends.

According to the present embodiment described above, following advantages can be obtained.

(1) Under a condition where the master bag 46 does not operate normally, when the brake operation is performed, the torque of the engine 10 is reduced according to the normalized brake pedal force. Thereby, the brake torque according to the driver's deceleration intention can be obtained and it is restricted to deteriorate the drivability.

(2) The brake pedal force is computed based on the pressure in the negative pressure chamber 46a and the brake oil pressure without providing a device which directly detects the brake pedal force. Thereby, the number of parts is restricted and the driver's deceleration intention can be correctly grasped.

(3) By adjusting the throttle opening of the throttle valve 16, the torque of the engine 10 is reduced. Thereby, the exhaust characteristic of the engine 10 is not deteriorated and it is restricted to deteriorate the drivability.

(4) By reducing the target drive torque of the vehicle, the generation torque of the engine 10 can be reduced. Thereby, a torque reducing processing of the engine 10 can be easily conducted.

(5) When the normalized brake pedal force exceeds “1”, the reduced amount of the driving torque is continuously increased as the brake pedal force is larger. Thereby, the brake torque according to a driver's deceleration intention can be suitably obtained and it is restricted to deteriorate the drivability.

(6) Upper guard process is processed on the throttle opening which is normally computed according to the normalized brake pedal force. Thereby, the normal operation of the throttle valve 16 is prioritized.

### Other Embodiments

The above-mentioned embodiments may be modified as follows.
In the above embodiment, when the brake pedal force is computed, the pressure in the negative pressure chamber 46a is detected by the negative pressure sensor 65. Alternatively, an intake pressure sensor is disposed in the intake pipe 12 downstream of the negative pressure supply pipe 44. The pressure in the negative pressure chamber 46a can be estimated based on the output of the intake pressure sensor. Since the check valve 48 is disposed in the negative pressure supply pipe 44, the pressure in the negative pressure chamber 46a does not always agree with the pressure detected by the intake pressure sensor. Thus, the pressure in the negative pressure chamber 46a can be estimated by use of the output of the intake pressure sensor and an operational history of the brake pedal 50. Even in this case, the advantage (2) of the above embodiment can be obtained.

For example, a brake pedal force sensor may be provided for the brake pedal 50.
In the above embodiment, the torque of the engine 10 is reduced by operating the throttle opening of the throttle valve 16. Alternatively, by adjusting a fuel injection quantity by the fuel injector 24 and an ignition timing of the spark plug 34, the torque of the engine 10 can be reduced. A valve characteristic of at least one of the intake valve 26 and the exhaust valve 38 can be adjusted. The valve characteristic includes an opening/closing timing or valve lift amount of the intake valve 26 and the exhaust valve 38. Even in this case, the advantages (1), (2), (4) and (5) of the above embodiment can be obtained.
In the above embodiment, under a condition where the road slope is zero, the road load torque is computed as the driving torque. Alternatively, a road slope detector detects the road slope and the road load torque can be computed as the driving torque.
In the above embodiment, the engine torque reducing process is performed by reducing the target driving torque of the vehicle. Alternatively, in FIG. 4, a generation torque of the engine 10 is computed based on a driving condition of the engine instead of step S42. The torque reducing amount is computed based on the normalized brake pedal force and total reduction gear ratio instead of step S48. In step S50, the target generation torque of the engine 10 is computed based on a difference between the generation torque and the reduced amount of the driving torque.
In the above embodiment, upper limit of the target throttle opening of the throttle valve 16 is computed. A smaller one of the normal throttle opening and the upper limit of the target throttle opening is computed as the target throttle opening. Alternatively, in a system where operation amount of an actuator of the engine is computed by use of a driving torque of the vehicle, the upper guard value is computed according to the normalized brake pedal force. In this case, the throttle opening is operated based on the guarded target driving torque.
In the above embodiment, the driving torque reduced amount is computed based on the normalized brake pedal force. Alternatively, in FIG. 4, step S46 is neglected, and the driving torque reduced amount can be computed based on the brake pedal force in step S48. Even in this case, the advantages (2) to (4) of the above embodiment can be obtained.
In the above embodiment, the computer determines whether the brake operation is performed based on whether the stop lamp switch is On. Alternatively, the computer determines whether the brake operation is performed based on a detected value of the oil pressure sensor 68.
In the above embodiment, the power generator is a gasoline engine. Alternatively, the power generator is a diesel engine. Besides, the power generator may be an internal combustion engine with electric machinery. The present invention can be applied to a power generator of which generation torque is adjusted according to the output value of the accelerator sensor 64.
In the above embodiment, the brake pedal force is converted into a brake oil pressure. Alternatively, a brake stroke sensor detects stepped amount of the brake pedal 50. The brake oil pressure is electrically controlled by an electric actuator based on the output of the brake stroke sensor. Alternatively, the electric actuator may control the brake torque based on the output of the brake stroke sensor.
In the above embodiment, the learning value of the brake pedal force is a simple moving average of the previous learning value and the current maximum value of the brake pedal force. Alternatively, the learning value of the brake pedal force may be a weighted moving average. Furthermore, the learning value of the brake pedal force may be a moving average of a plurality of learning value and the current maximum value of the brake pedal force.
In the above embodiment, the learning value of the brake pedal force is maximum value of the brake pedal force. Alternatively, the learning value may be a simple moving average of the brake pedal force.

What is claimed is:

1. A torque controller for an on-vehicle power generator comprising:
an accelerator information obtaining means for obtaining an operation condition of an accelerator operation member which is operated by a driver to indicate a generation of a driving torque of a vehicle;
a brake information obtaining means for obtaining an operation condition of a brake operation member which is operated by the driver to indicate a braking torque of the vehicle; and
a torque reducing means for reducing a torque of the on-vehicle power generator according to an output value of the brake information obtaining means when it is determined that both the accelerator operation and the brake operation are performed based on outputs of the accelerator information obtaining means and the brake information obtaining means.

2. A torque controller according to claim 1, wherein
further comprising
a brake system generating a braking torque according to an operation of the brake operation member, the brake system provided with a brake booster assisting an operation of the brake operation member by use of a negative pressure downstream of a throttle valve, wherein
the power generator is an internal combustion engine provided with the throttle valve.

3. A torque controller according to claim 2, wherein
the brake information obtaining means obtains an information of the operation force of the brake operation member based on an oil pressure of the brake system and a pressure in a negative pressure chamber of the brake booster or a negative pressure downstream of the throttle valve.

4. A torque controller according to claim 2, wherein
the torque reducing means reduces a torque of the internal combustion engine by operating the throttle valve.

5. A torque controller according to claim 1, further comprising:
a learning means for learning information about an operational condition of the brake operation member operated by the driver in a specified driving condition, wherein
the torque reducing means reduces the torque of the power generator based on the output value of the brake information obtaining means and the leaned information by the learning means.

6. A torque controller according to claim 1 further comprising
a target driving torque computing means for computing a target driving torque based on the vehicle speed, wherein
the torque reducing means reduces the torque of the power generator by reducing the target driving torque.
